(19) United States
(12) Patent Application Publication
(10) Pub. No.: US 2006/0228489 A1
(43) Pub. Date: Oct. 12, 2006

(54) Method for manufacturing metallic microstructure

(75) Inventors: Yuh Sung, Taoyuan (TW); Ming-Der Ger, Taoyuan (TW); Yu-Hsien Chou, Taoyuan (TW); Jinn-Luh Ou, Taipei (TW)

Correspondence Address: BACON & THOMAS, PLLC, 625 SLATERS LANE, FOURTH FLOOR, ALEXANDRIA, VA, 22314, US

(73) Assignee: CHUNG CHENG INSTITUTE OF TECHNOLOGY, NATIONAL DEFENSE UNIVERSITY, Taoyuan (TW)

(21) Appl. No.: 11/246,174

(22) Filed: Oct. 11, 2005

(30) Foreign Application Priority Data
Apr. 8, 2005 (TW) 94111266

(51) Int. Cl. B05D 1/18; B05D 3/02

(52) U.S. Cl. 427/437; 427/372.2; 427/443.1

(57) ABSTRACT

The present invention discloses a method for forming a metallic microstructure on a patterned surface of a substrate by a nonisothermal deposition (NTID) in an electroless plating solution. The substrate is immersed in the solution being heated by a heating device mounted on a bottom of an electroless plating reactor while the heated solution being cooled by a cooling device provided in the reactor, and thus a seed layer is formed the patterned surface of the substrate. The substrate is then immersed in an electroless plating solution with a back surface of the substrate lying on the bottom of the reactor, so that the exposed seed layer is thickened to form the metallic microstructure.

### FIELD OF THE INVENTION

The present invention is related to a method for forming a metallic microstructure on a substrate, such as a silicon substrate, by a nonisothermal deposition (NITD) in an electroless plating solution.

### BACKGROUND OF THE INVENTION

Making a metallic microstructure on a non-conductive substrate such as a silicon or GaAs substrate is inevitable, and in the fabrications of micro-electromechanical systems (MEMS) and integrated circuits (ICs). In order to deposit a metallic layer on the non-conductive substrate in an plating bath with suitable bonding strength, the non-conductive substrate must be subjected to a pretreatment, and an electroless plating to form a thin metallic layer, optionally an electroplating to thicken the metallic layer.

The conventional electroless plating requires the non-conductive substrate to be subjected to sensitizing and activating treatments prior to the electroless plating, wherein a noble metal such as Pd, Os and Pt is used. If the sensitizing and activating treatments can be avoided, the cost for forming a metallic layer on the non-conductive substrate by electroless plating can be saved and the environmental impact can be less severe.

Some of the inventors of the present application and their co-worker disclose a method and an apparatus for metallizing a surface of a substrate in U.S. Pat. No. 6,773,760 B, wherein a metallic layer is formed on a substrate by an nonisothermal deposition by electroless plating in a nonhomogenous heating electroless plating solution. The substrate is immersed in the electroless plating solution being heated by a heating device mounted on a bottom of an electroless plating reactor while the heated solution being cooled by a cooling device provided in the reactor, and the surface of the substrate and the bottom forms a gap of 0.1 to 1000 μm. Details of this US patent is incorporated herein by reference.

### SUMMARY OF THE INVENTION

A primary object of the present invention is to provide a method for forming a metallic microstructure on a substrate, and in particular a non-conductive substrate, by electroless plating without the sensitizing and activating treatments.

Another object of the present invention is to provide a method for forming a metallic microstructure free of voids or seams on a substrate by electroless plating, wherein the substrate has a trench and/or deep via.

Preferred embodiments of the present invention include (but not limited to) the following:

1. A method for forming a metallic microstructure, comprising the following steps:

a) providing a substrate having a patterned surface and a back surface opposite to the patterned surface; an electroless plating solution; and a electroless plating tank equipped with a heating device and a cooling device, wherein the solution is in the tank and the heating device is adapted to heat a bottom of the tank;

b) heating the solution in the tank by using the heating device while cooling the solution being heated by using the cooling device;

c) immersing the substrate in the solution so that a gap is formed between the patterned surface thereof and the bottom of the tank, wherein the solution exists in the gap and the bottom of the tank has a heating temperature of T₁;

d) removing the substrate from the tank;

e) immersing the substrate from step d) in another electroless plating solution different from or same as said electroless solution which has been introduced in a tank same as said tank with the back surface lying on the bottom of the tank, wherein the bottom of the tank has a heating temperature of T₂ and the cooling device is cooling the solution being heated; and

f) removing the substrate from the tank.

2. The method of Item 1, wherein said solution in step c) has a temperature gradient; and said solution in step e) has a temperature gradient.

3. The method of Item 1 further comprising g) washing and drying the substrate removed from the tank.

4. The method of Item 1, wherein T₁ is of 70-400° C. and T₂ is of 70-400° C.

5. The method of Item 1, wherein the gap is of 2 μm-300 μm.

6. The method of Item 1, wherein a metallic layer is deposited on the patterned surface of the substrate in step c) as a seed layer, wherein said metallic layer is Ni, Cu, Au, Ag, Co or a combination thereof.

7. The method of Item 6, wherein a metallic layer of Ni, Cu, Au, Ag, Co or a combination thereof is deposited on the seed layer formed on the patterned surface of the substrate in step e).

8. The method of Item 1, wherein said solution in step c) comprises a stabilizer which is (a) sulfide of Group VIA element, (b) oxygenated compound, (c) heavy metal ionic salt, (d) water soluble organic compound containing a group of —COOH, —OH or —SH, or a combination of (a) to (d); and said solution in step e) comprises a stabilizer which is (a) sulfide of Group VIA element, (b) oxygenated compound, (c) heavy metal ionic salt, (d) water soluble organic compound containing a group of —COOH, —OH or —SH, or a combination of (a) to (d).

9. The method of Item 1, wherein said solution in step c) comprises a stabilizer which is a heavy metal ionic salt of Pb²⁺, Sn²⁺, Sb³⁺, Cd²⁺, Zn²⁺, Bi³⁺, Tl³⁺ or a mixture thereof, and said solution in step e) comprises a stabilizer which is a heavy metal ionic salt of Pb²⁺, Sn²⁺, Sb³⁺, Cd²⁺, Zn²⁺, Bi³⁺, Tl³⁺ or a mixture thereof.

10. The method of Item 9, wherein the amount of the stabilizer in said solution in step c) is 0.225-1.35 mM, and the amount of the stabilizer in said solution in step e) is 0.225-1.35 mM.

11. The method of Item 8, wherein said sulfide of Group VIA element of (a) is a thiourea, thiosulfate, or C₆H₄SC(SH)N; and said oxygenated compound of (b) contains an ion of AsO₂⁻, IO₃⁻, NO₂⁻, or MoO₄²⁻.

### BRIEF DESCRIPTION OF THE DRAWINGS

FIG. 1 shows a schematic cross-sectional view of an electroless plating apparatus suitable for use in a method for manufacturing a metallic microstructure of the present invention, wherein the patterned surface 12 of the substrate 10 and the bottom 31 of the tank 30 forms a gap.

FIG. 2 shows a partial schematic view of the electroless plating apparatus shown in FIG. 1.

FIG. 3 shows a partial schematic view of the electroless plating apparatus shown in FIG. 1 with the back surface 11 of the substrate lying on the bottom 31 of the tank 30.

FIG. 4 show a SEM photograph of a metallic structure formed in EXAMPLE 1 of the present invention.

FIG. 5 show a SEM photograph of a metallic structure formed in EXAMPLE 2 of the present invention.

FIG. 6 is a plot showing the relationship between the surface tension and the concentration of a surfactant in the electroless plating solution.

FIG. 7 show a SEM photograph of a metallic structure formed in EXAMPLE 4 of the present invention.

FIG. 8 show a SEM photograph of a metallic structure formed in EXAMPLE 5 of the present invention.

FIG. 9 show a SEM photograph of a metallic structure formed in EXAMPLE 5 of the present invention.

FIGS. 10a to 10f show SEM photographs of metallic structures formed in EXAMPLE 6 of the present invention.

FIG. 11 show a SEM photograph of a metallic structure formed in EXAMPLE 7 of the present invention.

FIG. 12 show a SEM photograph of a metallic structure formed in EXAMPLE 8 of the present invention.

FIG. 13 show a SEM photograph of a metallic structure formed in EXAMPLE 9 of the present invention.

FIG. 14 show a SEM photograph of a metallic structure formed in EXAMPLE 10 of the present invention.

FIG. 15 show a SEM photograph of a metallic structure formed in EXAMPLE 11 of the present invention.

FIG. 16 show a SEM photograph of a metallic structure formed in EXAMPLE 12 of the present invention.

### DETAILED DESCRIPTION OF THE INVENTION

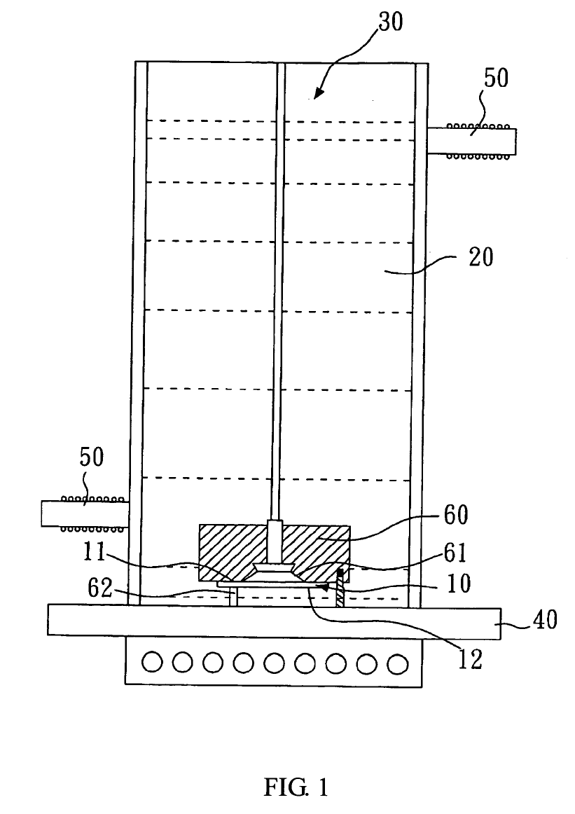

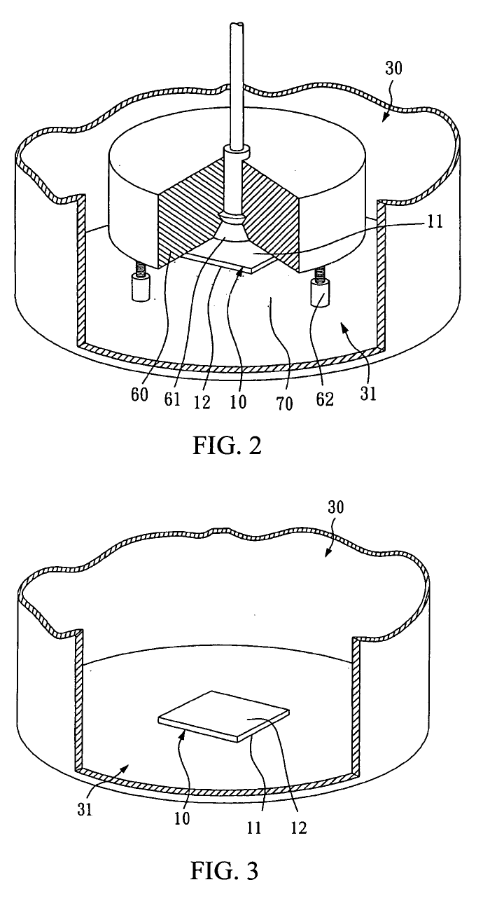

An electroless plating apparatus suitable for use in a method for manufacturing a metallic microstructure according to one of the preferred embodiments of the present invention is shown in FIGS. 1 and 2. First, a substrate 10 with patterns of trenches or deep-vias is cleaned with an organic solvent to removes oil stains and impurities from the surface thereof, and to increase the wet-ability of the surface thereof, before the substrate 10 is placed in the device. The size of the trenches or deep-vias can be of the order of nanometer, sub-micrometer or micrometer. Then, an electroless plating solution 20 is poured into a plating tank 30 of the apparatus, which is provided with a heating device 40 and a cooling device 50 for enabling the solution 20 to have a temperature gradient. The heating device 40 as shown in FIG. 1 is a heating plate, which is intimately attached to a bottom 31 of the tank 30. The substrate 10 is sucked on a base 60 with a vacuuming disc 61 provided on the base 60, wherein a back surface 11 of the substrate 10 is attached to the base 60 while exposing a patterned surface 12 of the substrate for nonisothermal deposition (abbreviated as NITD). When the temperature of the bottom 31 reaches the predetermined reaction temperature and the solution 20 has a temperature gradient, the substrate 10 is immersed in the solution 20 to undergo NITD. The base 60 has at least one adjustable pillar 62, which enables a desired clearance to be formed between the surface 12 of the substrate 10 and the heating device 40, and the gap can be varied by adjusting the pillar 62. For example, the gap can be around 3 mm, but if the clearance is too big, the metal particles will easily diffuse from the gap to the bulk solution. As a result, the amount of the deposited metal particles will decrease as the gap increases. In another example, a suitable width of the gap is around 50˜500 μm, which enables the solution 20 in the gap to result in spontaneous homogeneous nucleation, so that metal nano-particles 70 are deposited on the surface 12 of the substrate 10. The nano-particles will form an ultra-thin and continuous metal film with two-dimensional or three-dimensional array configuration, which is used as a seed layer. The substrate 10 is then removed from the tank 30, and detached from the base 60.

As shown in FIG. 3, the substrate 10 is again immersed in the solution 20 with its back surface 11 lying on the bottom 31 of the tank 30, that is the patterned surface 12 with the seed layer thereon is facing up, when the heating device 40 is set to a predetermined temperature and the bottom 31 reaches a desired temperature. The substrate 10 is heated by the bottom 31 and the patterned surface with the seed layer thereon is exposed to the solution 20, so that a second NITD occurs, thereby a metallic microstructure is formed on the surface 12 of the substrate 10.

The present invention can be better understood from the following examples which are for illustrative only, and not for limiting the scope of the present invention.

### EXAMPLE 1

A silicon substrate with trenches (width of trenches is 15 μm and depth is 35 μm) on the surface thereof was washed with acetone for 60 seconds at room temperature, and then was rinsed by deionized water for 20 seconds. The cleaned substrate was placed into a plating tank containing an electroless plating solution as shown in FIGS. 1 and 2, after the bottom of the tank had reached 140° C. The cooling device was turned on to let the temperature of the solution in the tank become non-isothermal. The gap between the surface of the substrate and the bottom of the tank was maintained at 150 μm. After 15 minutes of deposition reaction, the substrate was removed from the plating tank, and washed with deionized water for 20 seconds at room temperature. A continuous ultra-thin film as a seed layer was formed on the surface of the substrate. The composition of the plating bath is as follows:

| Composition of plating bath | Concentration |
|---|---|
| Nickel sulphate (NiSO₄.6H₂O) | 0.11M |
| Sodium phosphite (NaH₂PO₂.H₂O) | 0.28M |
| Sodium lactate (C₃H₅O₃Na) | 0.36M |
| Ammonium hydroxide (NH₄OH) | Adjust pH of the solution to about 9 |

The solution in the tank was replaced with a similar solution except that the pH value thereof was adjusted to about 5. The bottom of the tank was heated to a temperature of 120° C., and the substrate having a seed layer thereon was immersed in the solution with its back surface lying on the bottom of the tank. The exposed patterned surface of the substrate having a seed layer thereon was further deposited for two hours in the solution. The substrate was removed from the plating tank, washed with deionized water for 20 seconds at room temperature, and dried by nitrogen for 60 seconds. A metallic microstructure was formed on the patterned surface of the substrate.

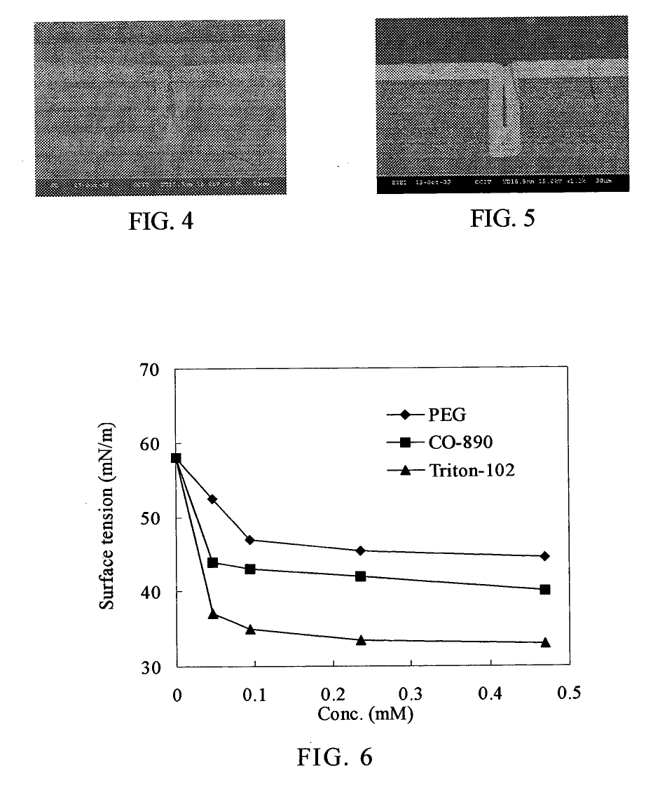

In this example, Ni-P plating is carried out by two-step NTID to form the metallic microstructure, wherein a dense, continuous and less roughness Ni seed layer is formed in the first NTID with a gap between the substrate and the heating device (bottom of the tank); and in the second NTID the surface having a seed layer thereon is exposed in the bulk solution to form the metallic microstructure. The result is shown in FIG. 4. As shown in FIG. 4, while the NTID is being performed, because of the non-linear diffusion problem, the portion near to the opening of the trench has a deposition rate greater than the portion in the trench. Defects such as voids and seams will occur, which will become severe as the heating temperature increases. Such situation is similar to the results of using electroplating method, i.e., voids and seams being formed in the microstructure, which are caused by non-homogeneous electric current density.

### EXAMPLE 2

The procedures in EXAMPLE 1 were repeated on a silicon substrate with trenches having a width of 12 μm and depth of 32 μm, except that lead nitrate [Pb(NO₃)₂] was added to the solution as a stabilizer in the second NTID with a concentration of Pb(NO₃)₂ of 0.225 mM. The result is shown in FIG. 5, from which one can see that the non-linear diffusion problem has been mitigated in view of a smaller void being formed. However, numerous pinholes have been observed on the surface of the deposited layer, and the thickness of the portion of the deposited layer inside the trench is slightly thinner than that of the portion outside the trench. It is believed that these defects are caused by a high surface tension, which results in that hydrogen bubbles generated in the reaction are adsorbed on the surface of the deposited layer, which in turn slows down the deposition rate.

### EXAMPLE 3

In this example three different surfactants were added to an electroless plating solution with different amounts, and the surface tensions were measured by using a surface tension meter (MODEL BVP-A3, KYOWA TNTERFACE SCIENCE CO., LTD., JAPAN). The surfactants used were those having a higher cloud point, which were CO-890 (Nonylphenoxypoly(ethyleneoxy) ethanol), Triton X-102 (Octylphenoxy polyethoxy ethanol) and PEG(1000) (polyethylene glycol). The composition of the solution is listed as follows:

| Composition of plating bath | Concentration |
|---|---|
| Nickel sulphate (NiSO₄.6H₂O) | 0.11M |
| Sodium phosphite (NaH₂PO₂.H₂O) | 0.28M |
| Sodium lactate (C₃H₅O₃Na) | 0.36M |
| Amino acetic acid (C₂H₅O₂N) | 0.13M |
| Ammonium hydroxide (NH₄OH) | Adjust pH of the solution to about 5 |
| Surfactant (CO-890, PEG or Triton | 0-0.47 mM |
| X-102) | |

The results are shown in FIG. 6, wherein Triton X-102 has the best performance on reducing the surface tension, which also has a higher cloud point. The surface tension is reduced to about 33 mN/m, when the concentration of Triton X-102 is 0.08 mM, and the curve becomes flat when the concentration increases. That means a concentration greater than 0.24 mM is not necessary, and a suitable range is of 0.16-0.24 mM.

### EXAMPLE 4

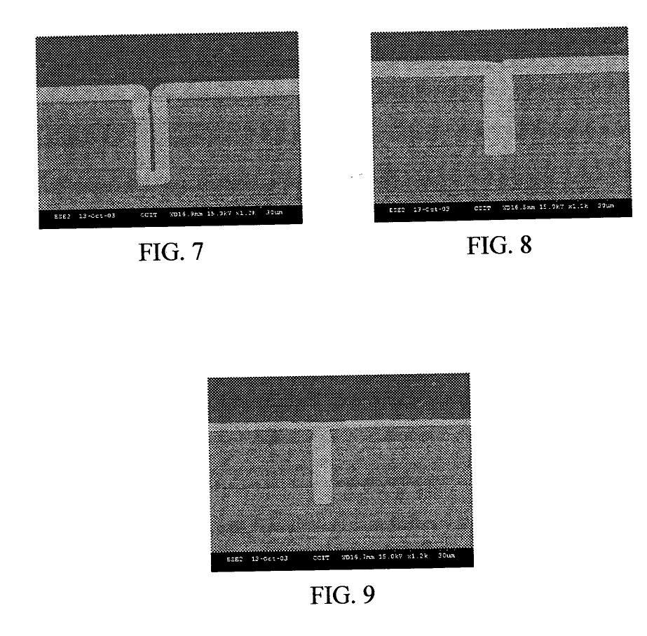

The procedures in EXAMPLE 2 were repeated, except that Triton X-102 was added to the solution in the second NTID with a concentration of 0.2 mM. The result is shown in FIG. 7, from which one can see that the non-linear diff-usion problem and the surface tension problem have been mitigated in view of an even thickness of the deposited layer and substantially no pinholes on the surface of the deposited layer.

### EXAMPLE 5

The procedures in EXAMPLE 4 were repeated, except that the concentration of Pb(NO₃)₂ of the solution in the second NTID was increased to 0.45 mM. The result is shown in FIG. 8, from which one can see that the non-linear diffusion problem has been solved because no defect is found in the deposited layer. Moreover, the adhesion of the deposited layer to the substrate is proved to be good by a peeling test using an adhesive tape (3M No. 250).

It can be understood from the results of EXAMPLES 4 and 5 that a higher concentration of the stabilizer [Pb(NO₃)₂] is helpful in mitigating the defect of the metallic microstructure having a trench of a high aspect ratio.

Another silicon substrate having a higher aspect ratio was tested by using a higher concentration of the stabilizer [Pb(NO₃)₂] in this example, wherein the width of the trench was 9 μm and the depth is 32 μm; and the concentration of the stabilizer [Pb(NO₃)₂] was 0.675 mM. The result is shown in FIG. 9. It can be seen from FIG. 9 that the thickness of the deposited outside the trench of the substrate decreases, i.e. the deposition on this portion is retarded at this high concentration of the stabilizer [Pb(NO₃)₂]. As a result, a shorter period of time for the subsequent chemical mechanical polishing (CMP) is required, which means the probability for the erosion of the metallic microstructure by the CMP composition is also reduced.

### EXAMPLE 6

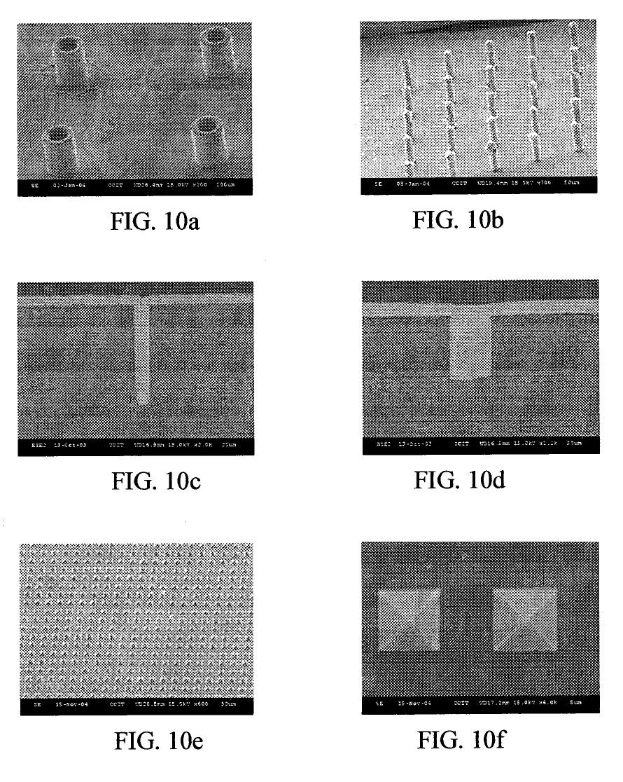

The procedures in EXAMPLE 1 were repeated on silicon substrates having different patterns, except that lead nitrate [Pb(NO₃)₂] and Triton X-102 were added to the solution in the second NTID with Pb(NO₃)₂ concentration of 0.675 mM and Triton X-102 concentration of 0.2 mM. The results are shown in FIGS. 10a to 10f, from which one can see that metallic microstructures having no defect are formed in this example. The ring structure shown in FIG. 10a has a thickness of 20 μm and a height of about 100 μm; the cylinder structure shown in FIG. 10b has a diameter of about 7 μm and a height of about 35 μm; the via shown in FIG. 10c has a diameter of about 4 μm and a depth of about 28 μm; the trench shown in FIG. 10d has a width of about 18 μm and a depth of about 30 μm; the pyramid shown in FIGS. 10e and 10f has a side of the base of about 4 μm and a height of about 4 μm.

### EXAMPLE 7

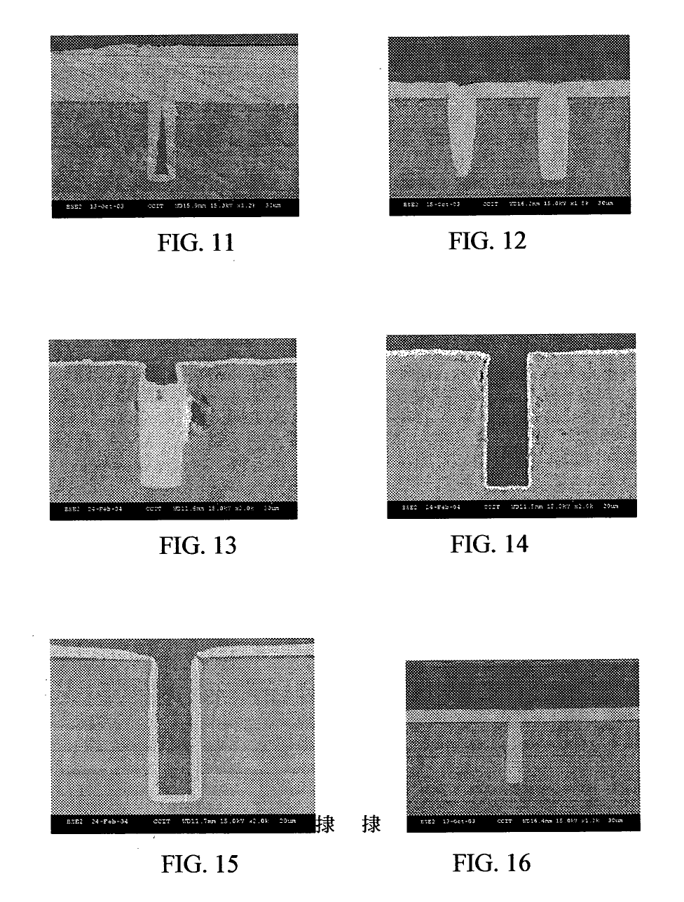

The procedures in EXAMPLE 1 were repeated on a silicon substrate with trenches having a width of 12 μm and depth of 32 μm, except that lead nitrate [Pb(NO₃)₂] and Triton X-102 were added to the solution in the second NTID with Pb(NO₃)₂ concentration of 0.675 mM and Triton X-102 concentration of 0.2 mM; and that the heating temperature of the bottom of the tank and the duration in the second NTID were changed to 200° C. and one hour. The result is shown in FIG. 11, from which one can see that the non-linear diffusion problem occurs again when the heating temperature is changed from 120° C. to 200° C. This may be caused by a less amount of the stabilizer acts on the surface of the deposited layer, which encounters more hindrance to be adsorbed on the surface of the deposited layer as the temperature of the substrate increases. At the same time the deposition rate increases as the temperature of the substrate increases, so that the thickness of the deposited layer is much thicker at the portion outside the trench.

### EXAMPLE 8

The procedures in EXAMPLE 7 were repeated on a silicon substrate with trenches having a width of 9 μm and depth of 30 μm, except that lead nitrate [Pb(NO₃)₂] added to the solution in the second NTID was increased to 1.35 mM to solve the non-linear diffusion problem at high substrate temperature. The result is shown in FIG. 12, from which one can see that the non-linear diffusion problem is solved. The higher amount of the stabilizer used increases the amount of the stabilizer to be adsorbed on the surface of the deposited layer, so that the deposition rate at the portion near the opening of the trench is inhibited, and thus a Ni microstructure free of void is formed.

### EXAMPLE 9

Procedures similar to those in EXAMPLE 1 were repeated on a silicon substrate with trenches having a width of 12 μm and depth of 32 μm by using the following copper electroless plating solution in the first and second NITD:

| Composition | Concentration |
|---|---|
| Copper sulfate (CuSO₄.5H₂O) | 0.03 M |
| Ethylene diaminetetraacetic acid (EDTA) | 0.28 M |
| Formaldehyde aqueous solution (37 wt %) | 0.15 M |
| Tetramethylamino hydroxide (TMAH) | pH adjusted to 12.5 |
| [(CH₃)₄NOH] | |
| Lead nitrate [Pb(NO₃)₂] | 0.675 mM |
| Triton X-102 | 0.2 mM |

The result is shown in FIG. 13, from which one can see that a Cu microstructure free of void is formed.

### EXAMPLE 10

Procedures similar to those in EXAMPLE 1 were repeated on a silicon substrate with trenches having a width of 12 μm and depth of 32 μm by using the following gold electroless plating solution in the first and second NITD, wherein the heating temperature of the bottom of the tank in the first NITD was changed from 140° C. to 100° C., and the heating temperature of the bottom of the tank in the second NITD was changed from 120° C. to 80° C.:

| Composition | Concentration |
|---|---|
| Potassium tetrachloroaurate (KAuCl₄.2H₂O) | 4.6 mM |
| Trisodium phosphate (Na₃PO₄.12H₂O) | 0.05 M |
| Dimethylamino borane (C₂H₈BN) | 0.034 M |
| Potasium hydroxide (KOH) | pH adjusted to 12.5 |
| Lead nitrate [Pb(NO₃)₂] | 0.675 mM |
| Triton X-102 | 0.2 mM |

The result is shown in FIG. 14, from which one can see that a continuous thin Au film of an even thickness of about 1 μm is formed.

### EXAMPLE 11

Procedures similar to those in EXAMPLE 10 were repeated by using the following silver-electroless plating solution in the first and second NITD:

| Composition | Concentration |
|---|---|
| Silver nitrate (AgNO₃) | 0.03 M |
| Hydrazine (N₂H₄.H₂O) | 0.1 M |
| Benzoic acid (C₆H₇O₂) | 0.004 M |
| Ammonium acetate (NH₄C₂H₃O₂) | 0.26 M |
| Ammonium hydroxide (NH₄OH) | pH adjusted to 9.5 |
| Lead nitrate [Pb(NO₃)₂] | 0.675 mM |
| Triton X-102 | 0.2 mM |

The result is shown in FIG. 15, from which one can see that a continuous thin Ag film of an even thickness of about 2.5 μm is formed.

### EXAMPLE 12

Procedures similar to those in EXAMPLE 1 were repeated on a silicon substrate with trenches having a width of 8 μm and depth of 27 μb by using the following cobalt electroless plating solution in the first and second NITD:

| Composition | Concentration |
|---|---|
| Cobalt sulfate (CoSO₄.7H₂O) | 0.02 M |
| Sodium phosphite (NaH₂PO₂.H₂O) | 0.1 M |
| Sodium citrate (Na₂C₆H₅O₇.2H₂O) | 0.04 M |
| Sodium hydroxide (NaOH) | pH adjusted to 10 |
| Lead nitrate [Pb(NO₃)₂] | 0.675 mM |
| Triton X-102 | 0.2 mM |

The result is shown in FIG. 16, from which one can see that a Co microstructure free of void is formed.

In the above examples Ni, Cu, Au, Ag and Co metallic microstructures of micro-level or submicro-level have been successfully prepared. The method of the present invention is simple, easy in operation and fast.

Although the present invention has been explained in relation to its preferred embodiment, it is to be understood that many other possible modifications and variations can be made without departing from the spirit and scope of the invention as hereinafter claimed.

1. A method for forming a metallic microstructure, comprising the following steps:
a) providing a substrate having a patterned surface and a back surface opposite to the patterned surface; an electroless plating solution; and a electroless plating tank equipped with a heating device and a cooling device, wherein the solution is in the tank and the heating device is adapted to heat a bottom of the tank;
b) heating the solution in the tank by using the heating device while cooling the solution being heated by using the cooling device;
c) immersing the substrate in the solution so that a gap is formed between the patterned surface thereof and the bottom of the tank, wherein the solution exists in the gap and the bottom of the tank has a heating temperature of T₁;
d) removing the substrate from the tank;
e) immersing the substrate from step d) in another electroless plating solution different from or same as said electroless solution which has been introduced in a tank same as said tank with the back surface lying on the bottom of the tank, wherein the bottom of the tank has a heating temperature of T₂ and the cooling device is cooling the solution being heated; and
f) removing the substrate from the tank.

2. The method of claim 1, wherein said solution in step c) has a temperature gradient; and said solution in step e) has a temperature gradient.

3. The method of claim 1 further comprising g) washing and drying the substrate removed from the tank.

4. The method of claim 1, wherein T₁ is of 70-400° C. and T₂ is of 70-400° C.

5. The method of claim 1, wherein the gap is of 2 μm-300 μm.

6. The method of claim 1, wherein a metallic layer is deposited on the patterned surface of the substrate in step c) as a seed layer, wherein said metallic layer is Ni, Cu, Au, Ag, Co or a combination thereof.

7. The method of claim 6, wherein a metallic layer of Ni, Cu, Au, Ag, Co or a combination thereof is deposited on the seed layer formed on the patterned surface of the substrate in step e).

8. The method of claim 1, wherein said solution in step c) comprises a stabilizer which is (a) sulfide of Group VIA element, (b) oxygenated compound, (c) heavy metal ionic salt, (d) water soluble organic compound containing a group of —COOH, —OH or —SH, or a combination of (a) to (d); and said solution in step e) comprises a stabilizer which is (a) sulfide of Group VIA element, (b) oxygenated compound, (c) heavy metal ionic salt, (d) water soluble organic compound containing a group of —COOH, —OH or —SH, or a combination of (a) to (d).

9. The method of claim 1, wherein said solution in step c) comprises a stabilizer which is a heavy metal ionic salt of Pb²⁺, Sn²⁺, Sb³⁺, Cd²⁺, Zn²⁺, Bi³⁺, Tl³⁺ or a mixture thereof, and said solution in step e) comprises a stabilizer which is a heavy metal ionic salt of Pb²⁺, Sn²⁺, Sb³⁺, Cd²⁺, Zn²⁺, Bi³⁺, Tl³⁺ or a mixture thereof.

10. The method of claim 9, wherein the amount of the stabilizer in said solution in step c) is 0.225-1.35 mM, and the amount of the stabilizer in said solution in step e) is 0.225-1.35 mM.

11. The method of claim 8, wherein said sulfide of Group VIA element of (a) is a thiourea, thiosulfate, or C₆H₄SC(SH)N; and said oxygenated compound of (b) contains an ion of AsO₂⁻, IO₃⁻, NO₂⁻, or MoO₄²⁻.
